(19) United States
(12) Patent Application Publication
(10) Pub. No.: US 2011/0265377 A1
(43) Pub. Date: Nov. 3, 2011

(54) Roof Vegetation Cassette

(75) Inventors: Kai Tietjen, Thedinghausen (DE); Sven Adamietz, Bremen (DE)

(73) Assignee: Soiltec GMBH, Achim (DE)

(21) Appl. No.: 12/994,397

(22) PCT Filed: Apr. 28, 2010
(86) PCT No.: PCT/EP10/02599

§ 371 Date: Jan. 26, 2011

(30) Foreign Application Priority Data
Dec. 15, 2009 (DE) 102009058217.7

(51) Int. Cl. A01G 9/02; E04D 13/00; A01G 1/00

(52) U.S. Cl. 47/65.7; 47/65.9; 47/66.7; 52/173.1

(57) ABSTRACT

A roof vegetation cassette for accommodating a substrate for roof vegetation.

### BACKGROUND OF THE INVENTION

1. Technical Field

This invention relates to a roof vegetation cassette.

2. Prior Art

Conventional roof vegetations are constructed of two or more plies successively applied atop a roof. Sedum plants are widely used. They can be cultivated on mats and placed in that form on the prepared roof or on the plies already applied atop the roof. Alternatively, the sedum plants are cultivated once on the roof on an appropriate substrate layer. This is particularly laborious and cannot be automated, since every roof has a different construction. Similarly, the pre-cultivation of sedum mats with subsequent rolling up, hoisting to the roof and unrolling on the roof is relatively costly and inconvenient. Accurate watering is important in pre-cultivation. Long periods of dryness are harmful to the young plants at this stage. Plants can become damaged in the course of the mats being rolled up.

### BRIEF SUMMARY OF THE INVENTION

It is an object of the present invention to provide an economical alternative for the vegetation of roofs.

We have found that this object is achieved by a roof vegetation cassette. This roof vegetation cassette includes at least one compartment, which preferably is open at the top and includes a bottom wall and side walls. The cassette comprising one or more compartments is automatically fillable as are a multiplicity of cassettes. Cassettes are also easy to handle automatically. The bottom wall can have a stiffness suitable therefor. The bottom and side walls have a stabilizing effect.

The walls of the cassettes can be porous, solid or perforate, consist of hard or soft material, be water permeable or water impermeable. At least a low permeability to water is preferred.

Further features of the invention will be apparent in the claims and the rest of the description.

### BRIEF DESCRIPTION OF THE DRAWINGS

Advantageous embodiments of the invention will now be more particularly described with reference to drawings, where

FIG. 1 shows a top view of a roof vegetation cassette,

FIG. 2 shows the roof vegetation cassette from underneath,

FIG. 3 shows a longitudinal section of the roof vegetation cassette,

FIG. 4 shows a cross section of the roof vegetation cassette, and

FIG. 5 shows a perspective view of the roof vegetation cassette at an angle from above.

### DETAILED DESCRIPTION OF PREFERRED EMBODIMENTS

The cassette advantageously includes walls and/or floors of rebond foam, more particularly at a density for the rebond foam in the range from 50 kg to 140 kg/m³, preferably about 80 kg/m³. Preference is given to using PU foam. It is also possible to use different materials of construction for side walls on the one hand and floor walls on the other. However, a unitary material of construction is preferable. The rebond foam mentioned is easy to work, can be trimmed and glued, and is available at low cost. More particularly, the foam has elastic resilience.

The material used is preferably of low flammability in accordance with German fire control class B1. Materials of class B2 can also be used.

According to a further concept of the invention, the walls and/or floors are root penetrable and/or water storing. Preferably, the material used is as such root penetrable and/or water storing, for example the aforementioned rebond foam.

The walls or floors shall ideally also be drainage capable. Water is stored up to a certain quantity in pores or similar interstitial spaces, for example via capillary action. Further water supplied, for example via artificial watering or via precipitation, flows off or seeps out of walls and floors. These are therefore preferably not sealed water-impermeably on the outside, but are openly porous in particular.

The walls or floors are preferably “optically dense” and each have an uninterrupted, compact construction. Apertures, openings, slots, cutouts and the like are not provided, so that even small amounts of the substrate cannot pass through the walls or floors absent sufficient interstitial spaces. The compartments of the cassette are only open at the top, i.e., outside the walls and floors.

The material of which the walls and floors are constructed is sufficiently soft and/or permeable to ensure the root penetrability mentioned, particularly with regard to sedum.

The properties mentioned are ensured best when rebond foam is used. However, other materials of construction, which have the aforementioned properties together or individually, can likewise be used, examples being substances that are processible by casting, blowing, spraying, pressing or foaming, such as particulate or fibrous materials, alone or combined with matrix materials to achieve a firmer and more durable bond. For instance, natural fibers or scraps of paper can be pressed together with a bond-enhancing binder as matrix material to form walls or floors. Water storage, water permeability/drainage capability and/or root penetration are determined by selecting the fibers and matrix materials.

The water-storing property in particular makes it possible to produce the cassette at low cost by filling with substrate, including earth, fertilizer, shoots or seeds, and with a first defined quantity of water. This is stored in the walls or floor of the cassette. As a result, further water does not have to be added for a prolonged period. This cuts the costs of growing at ground level and further care on the roof. The roof vegetation cassette is preferably placed with the pre-cultivated plants on the roof to be vegetated, after appropriate preparation thereof. The cassette remains on the roof.

According to a further concept of the invention, the roof vegetation cassette includes two or more open-top compartments arranged beside and/or behind each other. The size of the individual compartments and the height of the walls in between can be determined as a function of the roof pitch and/or other parameters. A typical vegetated roof is suitably served with, for example, cassettes measuring 60 cm by 100 cm with an inner space height of about 3 cm, wall thickness of about 1 cm and a subdivision into 3 by 7 compartments, each measuring about 19 cm by 14 cm on the inside. Other dimensions and subdivisions are possible, at least depending on the overall mass, the plants used, the stability of the cassette and the roof pitch.

According to a further concept of the invention, at least one compartment contains inorganic substances, preferably as water store, more particularly natural pumice, expanded clay, lava, lavastrat and/or expanded slate. The inorganic substances are part of the substrate. Mineral substances are concerned in particular.

Preference is given to an embodiment wherein the inorganic substances have a particle size of 0.5 mm to 10 mm, preferably up to about 3 mm. Additionally or alternatively, the following densities are preferred:
natural pumice 0.3 to 1.1 kg/l or t/m³
expanded clay 0.35 to 1.8 kg/l
lava/lavastrat 0.75 to 1.5 kg/l
expanded slate 0.9 to 1.8 kg/l.

According to a further concept of the invention, at least one compartment contains a three-dimensional random-laid scrim, drainage braid and/or storage fleece, wherein these parts are arranged in the compartment in addition to the substrate. The random-laid scrim or drainage braid has for example a basis weight of 300-800 g/m² coupled with a layer thickness of 5-25 mm and preferably consists of PP (polypropylene).

The inorganic substances mentioned and/or the random-laid scrim, drainage braid or storage fleece are intended to enhance the water storage capability. In addition, noxiants can be bound or filtered. Moreover, chemical-physical processes can be initiated, one example being a change in the pH through use of appropriate inorganic substances. The random-laid scrim, drainage braid or storage fleece can each be inorganic, mineral or organic or include corresponding constituents. It is also possible to use composite materials therefore or for the walls and floors.

According to a further concept of the invention, the substrate contains organic material, more particularly 5 weight percent or more. Preference is given more particularly to at most 50 weight percent of organic material. As for the rest, the substrate contains inorganic substances, seed, shoots or plants and fertilizer. The organic material preferably comprises earth or soil.

The cassette is advantageously made by means of cut-out and mutually adhered or welded walls. Manufacture as a drawn or pressed article is also possible.

According to a further concept of the invention, the roof vegetation cassette includes reinforcing ribs on its underside, more particularly at least in one direction centrally under the top-sidedly formed compartments.

According to a further concept of the invention, the roof vegetation cassette is equipped on its underside with grooves, for better drainage and/or to accommodate reinforcing profiles and/or slatting for shearing force absorption on a pitched roof.

The under-sided grooves preferably extend centrally underneath top-sided compartments and/or underneath top-sided walls. More particularly, the grooves extend directly underneath top-sided walls and parallel thereto. It is also possible to have a combination of the arrangements mentioned, viz., mutually crossing grooves, in which case the grooves preferably extend in one direction centrally underneath the top-sided compartments and in a correspondingly transverse direction directly underneath the top-sided walls.

The under-sided grooves preferably have a wedge-shaped cross section, namely with decreasing width in the direction of the top-sided compartments or walls. Conversely, the top-sided walls can also be formed to have a wedge-shaped cross section, namely with increasing width in the direction of the under-sided grooves. Preference, however, is given to top-sided walls of rectangular cross section.

The invention also provides for the use of a cassette for the preparation and production of roof vegetations. This type of use for cassettes is hitherto unknown.

The invention finally also includes a process for vegetating a roof and a roof supporting roof vegetation cassettes.

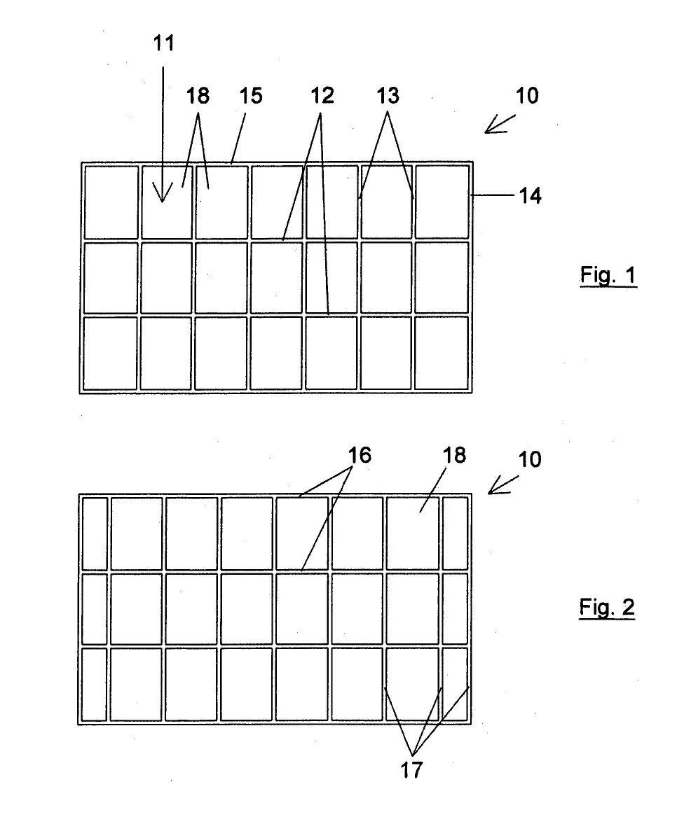

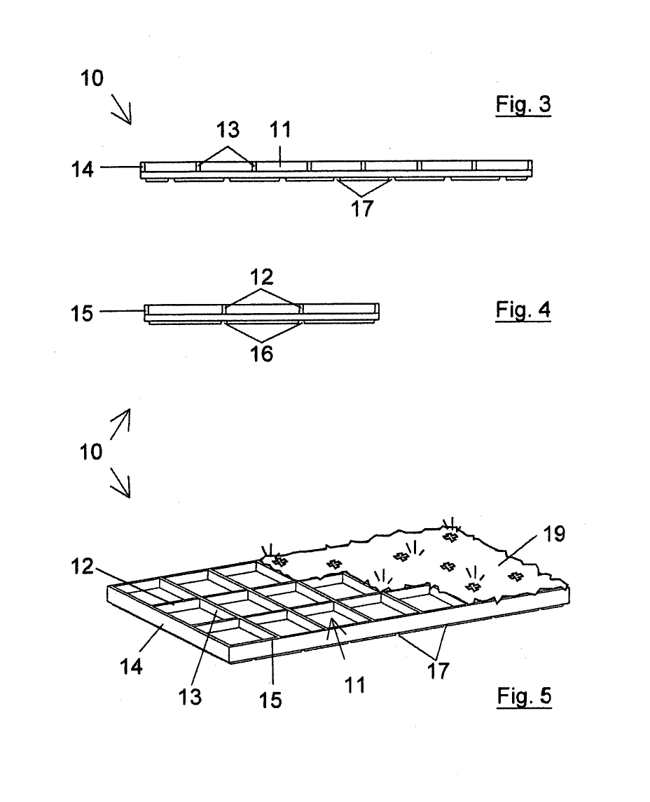

Advantageous embodiments of the invention will now be more particularly described with reference to FIGS. 1-5.

A roof vegetation cassette 10 has a rectangular shape and includes, beside and behind each other, a plurality of rectangular open-top compartments 11, namely seven compartments in the longitudinal direction of the cassette and three compartments in the transverse direction, all separated by longitudinal walls 12 and transverse walls 13. Outer transverse walls are referred to as end walls 14 and outer longitudinal walls are referred to as longitudinal side walls 15.

The cassette 10 preferably has external dimensions of about 100 cm (length) by 60 cm (width) by 5 cm (height). The cassettes are formed from strips or panels of rebond foam, more particularly PU foam, having a density of about 80 kg/m³. Individual strips or panels are easy to cut to size and adhere to each other. Depending on numbers off, the cassettes can also be produced in one piece, for example by casting or pressing.

The cassette 10 is planar on its underside except for a grid of transversely and longitudinally extending grooves 16, 17, see floor wall 18 in FIG. 2. The size of the grid formed in this way corresponds to the size of the grid formed form longitudinal walls 12 and transverse walls 13. However, the transverse grooves 17 are offset in that they are arranged approximately centrally between the transverse walls 13. According to FIG. 2, the longitudinal grooves 16 are directly underneath the longitudinal walls 12. However, an offset is possible here too, as is an arrangement of the transverse grooves 17 directly underneath the transverse walls 13.

The grooves 16, 17 can perform two functions in particular. First, drainage is possible via the grooves. A buildup of wetness is avoided. Secondly, individual grooves can serve to accommodate reinforcing profiles. This provides for better absorption of shearing forces arising on pitched roofs.

The compartments 11 of the cassettes are preferably filled with substrate 19 at ground level. The substrate comprises more particularly earth with seeds or shoots suitable for growing the roof vegetation, with or without fertilizer. Vegetation with sedum is preferred. After filling, the cassettes are placed on the roof to be vegetated and fixed there. Culturing to the point where visible plants emerge can take place at ground level or on the roof. Culturing is preferably carried out completely at ground level. This allows for superior monitoring of the watering. Watering can take place at larger intervals, for example for a first time in connection with the filling of the compartments with substrate and then for a second time only after a certain interval.

Owing to the use of the rebond foam of the type mentioned, the walls of the cassette—including the floor wall 18—are root penetrable and water storing. Depending on the material of construction used, a long service life in line with the predicted service life of the roof is also possible.

The preferably fully vegetated cassettes 10 are placed on a roof (not shown) beside and behind each other without gaps. Spaces left on the roof as a result of the grid size can be covered with sub-size cassettes. These are easy to make by dividing and separating individual cassettes 10.

The individual walls 12 to 15 have a thickness of about 1 cm. The floor wall 18 needs to have load-bearing capacity and so is somewhat thicker at about 3 cm minus the occasional grooves 16, 17 of 1 cm depth and width. There are also circumferential grooves 16, 17 extending along the edge sides, i.e., underneath the end walls 14 and longitudinal side walls 15.

FIG. 5 shows a cassette 10 partly filled with substrate 19. In practice, it is envisioned that all compartments 11 are filled with substrate.

### LIST OF REFERENCE NUMERALS

10 roof vegetation cassette

11 compartments

12 longitudinal walls

13 transverse walls

14 end walls

15 longitudinal side walls

16 longitudinal grooves

17 transverse grooves

18 floor wall

19 substrate

1. A roof vegetation cassette.

2. The cassette according to claim 1, comprising walls (12 to 15) and/or floors (18) of rebond foam wherein the rebond foam has a density in the range from 50 kg to 140 kg/m³.

3. The cassette according to claim 2, wherein the walls (12 to 15) and/or floors (18) are root penetrable and/or water storing and/or drainage capable.

4. The cassette according to claim 2, further comprising at least two open-top compartments (11) arranged beside and/or behind each other.

5. The cassette according to claim 2, further comprising a substrate filling.

6. The cassette according to claim 2, further comprising a substrate filling with plants.

7. The cassette according to claim 4, wherein at least one of the compartments (11) contains inorganic substances as a water store.

8. The cassette according to claim 7, wherein the inorganic substances have a particle size of 0.5 mm to 10 mm.

9. The cassette according to claim 4, wherein at least one of the compartments contains a random-laid scrim, a drainage braid and/or a storage fleece.

10. The cassette according to claim 5, wherein the substrate contains organic material.

11. The cassette according to claim 2, further comprising mutually adhered or welded walls (12 to 15).

12. The cassette according to claim 4, further comprising under-sided reinforcing ribs at least in one direction centrally underneath the compartments (11).

13. The cassette according to claim 4, further comprising under-sided grooves (16, 17) at least in one direction centrally underneath the compartments (11) and/or underneath the walls.

14. The cassette according to claim 4, wherein the walls or floors are optically dense, devoid of apertures, openings, slots or cutouts.

15. The use of one or more cassettes for the preparation and production of roof vegetations.

16. A process for vegetating a roof, comprising the steps of filling cassettes with a substrate at ground level, growing vegetation out of the substrate at ground level, and fixing the cassettes on the roof to be vegetated.

17. A roof supporting one or more roof vegetation cassettes lying thereon.

18. The cassette according to claim 2, wherein the rebond foam has a density in the range of about 80 kg/m³.

19. The cassette according to claim 6, wherein the plants are sedum.

20. The cassette according to claim 5, wherein the a substrate filling is selected from the group consisting of earth or earthlike substances, seed or shoots, fertilizer, and combinations thereof.

21. The cassette according to claim 7, wherein the inorganic substances are selected from the group consisting of natural pumice, expanded clay, lava, lavastrat, expanded slate, and combinations thereof.

22. The cassette according to claim 8, wherein the inorganic substances have a particle size of up to about 3 mm.

23. The cassette according to claim 10, wherein the substrate contains organic material in the amount of at least 5 weight percent.
